(19) United States
(12) Patent Application Publication
(10) Pub. No.: US 2025/0377444 A1
(43) Pub. Date: Dec. 11, 2025

(54) OBJECT DETECTION APPARATUS

(71) Applicant: Honda Motor Co., Ltd., Tokyo (JP)

(72) Inventors: Shunsuke Konishi, Saitama (JP); Daichi Saeki, Saitama (JP); Shuhei Masuoka, Utsunomiya-shi (JP)

(21) Appl. No.: 19/224,850

(22) Filed: Jun. 1, 2025

(30) Foreign Application Priority Data
Jun. 7, 2024 (JP) 2024-092685

(51) Int. Cl. G01S 7/48; G01S 17/42; G01S 17/58; G01S 17/89; G01S 17/931

(52) U.S. Cl. CPC G01S 7/4802; G01S 7/4808; G01S 17/42; G01S 17/58; G01S 17/89; G01S 17/931

(57) ABSTRACT

An object detection apparatus including a microprocessor configured to: acquire point cloud data from a Lidar, the point cloud data including position information of measurement points and relative moving speeds of the measurement points; estimate an absolute moving speed of the subject vehicle; classify the measurement points into moving points and stationary points based on absolute moving speeds of the measurement points, calculated based on the relative moving speeds; generate distance data indicating distances to the moving points from the subject vehicle, and speed data indicating the absolute moving speeds of the moving points; perform a kernel operation on each of the distance data and the speed data, and calculate differences in the distance data and the speed data among the moving points; and detect positions and sizes of moving objects in the surroundings of the subject vehicle based on a result of the kernel operation.

### CROSS-REFERENCE TO RELATED APPLICATION

This application is based upon and claims the benefit of priority from Japanese Patent Application No. 2024-092685 filed on Jun. 7, 2024, the content of which is incorporated herein by reference.

### BACKGROUND

### Technical Field

The present invention relates to an object detection apparatus configured to detect an object in the surroundings of a vehicle.

### Related Art

As this type of device, a device that detects a moving object using three-dimensional point cloud data that has been acquired by a LiDAR is known (see, for example, Japanese Patent No. 7126633).

However, in a case of detecting the object using the point cloud data as in the device described in Japanese Patent No. 7126633, a large volume of point cloud data acquired by the LiDAR is input, and thus there is a possibility that the processing load of the device might be increased.

### SUMMARY

An aspect of the present invention is an object detection apparatus including: a detector mounted on a mobile body and configured to irradiate a surrounding of the mobile body with an electromagnetic wave to detect an exterior environment situation in the surrounding of the mobile body based on a reflected wave; and a microprocessor. The microprocessor is configured to perform: acquiring point cloud data for every predetermined period of time, the point cloud data including three-dimensional position information of a plurality of measurement points on a surface of an object from which the reflected wave is obtained and first speed information indicating a relative moving speed of the plurality of measurement points; acquiring second speed information indicating an absolute moving speed of the mobile body; calculating absolute moving speeds of each of the plurality of measurement points, based on the first speed information and the second speed information; classifying the plurality of measurement points into a plurality of moving points and a plurality of stationary points, the plurality of moving points having absolute values of the absolute moving speeds calculated in the calculating equal to or higher than a predetermined speed, the plurality of stationary points having the absolute values lower than the predetermined speed; generating distance data indicating distances to the plurality of moving points from the subject vehicle and speed data indicating the absolute moving speeds of the plurality of moving points calculated in the calculating; performing a kernel operation on each of the distance data and the speed data with each of the plurality of moving points as a center position, and calculating differences between the distance data and the speed data between the plurality of moving points; detecting a position and a size of each of a plurality of moving objects in the surroundings of the mobile body, based on a result of the kernel operation.

### BRIEF DESCRIPTION OF DRAWINGS

The objects, features, and advantages of the present invention will become clearer from the following description of embodiments in relation to the attached drawings, in which:

FIG. 1 is a block diagram illustrating a configuration of a substantial part of a vehicle control apparatus including an object detection apparatus according to the embodiment of the present invention;

FIG. 2A is a diagram illustrating an example of a three-dimensional space when viewed from a viewpoint of a LiDAR;

FIG. 2B is a diagram illustrating an example of point cloud data with regard to the three-dimensional space of FIG. 2A;

FIG. 2C is a diagram illustrating an example of distance data;

FIG. 2D is a diagram illustrating an example of absolute speed data;

FIG. 3A is a diagram schematically illustrating the distance data;

FIG. 3B is a diagram illustrating an example of a kernel applied to the distance data;

FIG. 3C is a diagram illustrating another example of a kernel applied to the distance data;

FIG. 4A is a diagram illustrating an example of an operation result of difference calculation processing with regard to the distance data;

FIG. 4B is a diagram illustrating an example of an operation result of difference calculation processing with regard to the absolute speed data;

FIG. 5A is a diagram illustrating an operation result of the Hadamard product;

FIG. 5B is a diagram illustrating an example of the identifier that has been assigned to measurement points in the kernel;

FIG. 6A is a diagram for describing a connection processing of moving object;

FIG. 6B is a diagram for describing the connection processing of moving object; and

FIG. 7 is a flowchart illustrating an example of processing to be performed by of the controller in FIG. 1.

### DETAILED DESCRIPTION

Hereinafter, embodiments of the present invention will be described with reference to the drawings. An object detection apparatus according to an embodiment of the present invention is applicable to a vehicle having a self-driving capability, that is, a self-driving vehicle. Note that a vehicle to which the object detection apparatus according to the present embodiment is applied will be referred to as a subject vehicle to be distinguished from other vehicles, in some cases. The subject vehicle may be any of an engine vehicle having an internal combustion (engine) as a traveling drive source, an electric vehicle having a traveling motor as the traveling drive source, and a hybrid vehicle having an engine and a traveling motor as the traveling drive source. The subject vehicle is capable of traveling not only in a self-drive mode that does not necessitate the driver's driving operation but also in a manual drive mode of the driver's driving operation.

While a self-driving vehicle is moving in the self-drive mode (hereinafter, referred to as self-driving or autonomous driving), such a self-driving vehicle recognizes an exterior environment situation in the surroundings of the subject vehicle, based on detection data of an in-vehicle detector such as a camera or a light detection and ranging (LiDAR). The self-driving vehicle generates a driving path (a target path) at a predetermined time elapsed after the current time, based on a recognition result, and controls an actuator for driving so that the subject vehicle travels along the target path.

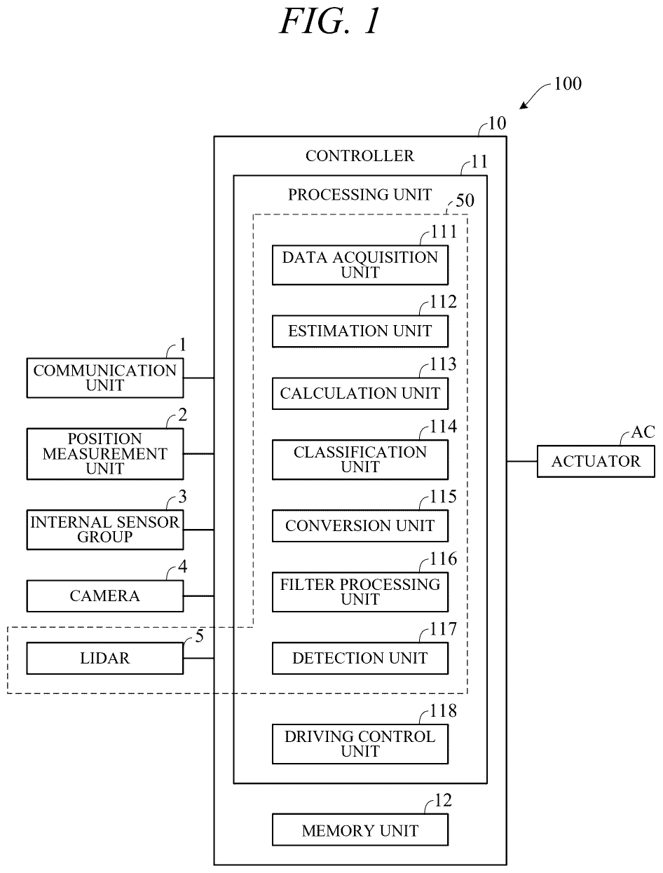

FIG. 1 is a block diagram illustrating a configuration of a substantial part of a vehicle control apparatus 100 including the object detection apparatus. The vehicle control apparatus 100 includes a controller 10, a communication unit 1, a position measurement unit 2, an internal sensor group 3, a camera 4, a LiDAR 5, and a traveling actuator AC. In addition, the vehicle control apparatus 100 includes an object detection apparatus 50, which constitutes a part of the vehicle control apparatus 100. The object detection apparatus 50 detects an object in the surroundings of a vehicle, based on detection data of the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for every predetermined management area, for example, a wireless LAN, Wi-Fi (registered trademark), Bluetooth (registered trademark), and the like. The acquired map information is output to a memory unit 12, and the map information is updated. The position measurement unit (GNSS unit) 2 includes a position measurement sensor for receiving a position measurement signal transmitted from a position measurement satellite. The positioning satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle.

The internal sensor group 3 is a generic term for a plurality of sensors (internal sensors) that detect a traveling state of the subject vehicle. For example, the internal sensor group 3 includes a vehicle speed sensor that detects the vehicle speed of the subject vehicle, an acceleration sensor that detects the acceleration in a front-rear direction and the acceleration (lateral acceleration) in a left-right direction of the subject vehicle, a rotation speed sensor that detects the rotation speed of the traveling drive source, a yaw rate sensor that detects the rotation angular speed around the vertical axis of the center of gravity of the subject vehicle, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the surroundings of the subject vehicle (a forward side, a rearward side, and lateral sides). The LiDAR 5 irradiates a three-dimensional space in the surroundings of the subject vehicle with an electromagnetic wave (a reflected wave), and detects an exterior environment situation in the surroundings of the subject vehicle, based on the reflected wave. More specifically, the electromagnetic wave (a laser beam or the like) that has been irradiated from the LiDAR 5 is reflected on and returned from a certain point (a measurement point) on the surface of an object, and thus the distance from the laser source to such a point, the intensity of the electromagnetic wave that has been reflected and returned, the relative speed of the object located at the measurement point, and the like are measured. The electromagnetic wave of the LiDAR 5, which is attached to a predetermined position (a front part) of the subject vehicle is scanned in a horizontal direction and a vertical direction with respect to the surroundings (a forward side) of the subject vehicle. Thus, the position, the shape, the relative moving speed, and the like of an object (a moving object such as another vehicle or a stationary object such as a road surface or a structure) on a forward side of the subject vehicle are detected. A target object detected by the LiDAR 5 will be referred to as an object including a person. Therefore, a moving object includes a moving person (a pedestrian or the like), in addition to a moving vehicle such as an automobile or a bicycle. Note that hereinafter, the above three-dimensional space will be represented by an X axis along an advancing direction of the subject vehicle, a Y axis along a vehicle width direction of the subject vehicle, and a Z axis along a height direction of the subject vehicle. Therefore, the above three-dimensional space will be referred to as an XYZ space, in some cases.

The actuator AC is a traveling actuator for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuator AC also includes a brake actuator that operates a braking device of the subject vehicle and a steering actuator that drives the steering device.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits (not illustrated) such as an I/O interface. Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores highly precise detailed map information (referred to as high-precision map information). The high-precision map information includes position information of roads, information of road shapes (curvatures or the like), information of road gradients, position information of intersections and branch points, information of the number of traffic lanes (traveling lanes), information of traffic lane widths and position information for every traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition, the memory unit 12 stores programs for various types of control, information such as a threshold for use in a program, and setting information for the in-vehicle detection unit such as the LiDAR 5.

The processing unit 11 includes, as a functional configuration, a data acquisition unit 111, an estimation unit 112, a calculation unit 113, a classification unit 114, a conversion unit 115, a filter processing unit 116, an object detection unit (hereinafter, simply referred to as a detection unit) 117, and a driving control unit 118. Note that as illustrated in FIG. 1, the data acquisition unit 111, the estimation unit 112, the calculation unit 113, the classification unit 114, the conversion unit 115, the filter processing unit 116, and the detection unit 117 are included in the object detection apparatus 50. Details of the data acquisition unit 111, the estimation unit 112, the calculation unit 113, the classification unit 114, the conversion unit 115, the filter processing unit 116, and the detection unit 117 included in the object detection apparatus 50 will be described later.

In the self-drive mode, the driving control unit 118 generates a target path, based on an exterior environment situation in the surroundings of the vehicle, including a size, a position, a moving speed, and the like of an object that has been detected by the object detection apparatus 50. Specifically, the driving control unit 118 generates the target path to avoid collision or contact with the object or to follow the object, based on the size, the position, the moving speed, and the like of the object that has been detected by the object detection apparatus 50. The driving control unit 118 controls the actuator AC so that the subject vehicle travels along the target path. Specifically, the driving control unit 118 controls the actuator AC along the target path to adjust an accelerator opening or to actuate a braking device or a steering device. Note that in the manual drive mode, the driving control unit 118 controls the actuator AC in accordance with a traveling command (a steering operation or the like) from the driver that has been acquired by the internal sensor group 3.

Details of the object detection apparatus 50 will be described. As described above, the object detection apparatus 50 includes the data acquisition unit 111, the estimation unit 112, the calculation unit 113, the classification unit 114, the conversion unit 115, the filter processing unit 116, and the detection unit 117. The object detection apparatus 50 further includes the LiDAR 5.

The data acquisition unit 111 acquires, as detection data of the LiDAR 5, four-dimensional data (hereinafter, referred to as point cloud data) including position information indicating three-dimensional position coordinates of a measurement point on a surface of the object from which the reflected wave of the LiDAR 5 is obtained, and speed information indicating a relative moving speed of the measurement point. The point cloud data is acquired by the LiDAR 5 in units of frames, specifically, at a predetermined time interval (a time interval determined by a frame rate of the LiDAR 5).

The estimation unit 112 estimates an absolute moving speed (a speed vector in X, Y, Z coordinates) of the subject vehicle, based on the point cloud data that has been acquired by the data acquisition unit 111. Here, estimation of the absolute moving speed of the subject vehicle by the estimation unit 112 will be described.

First, the estimation unit 112 extracts point cloud data obtained by removing information of measurement points corresponding to a three-dimensional object from the point cloud data that has been acquired by the data acquisition unit 111, that is, point cloud data corresponding to a road surface (hereinafter, referred to as road surface point cloud data) in the surroundings of the subject vehicle. The estimation unit 112 calculates, in the following equation (i), a unit vector ei indicating the direction of a relative moving speed vi, based on the road surface point cloud data, that is, position coordinates (xi, yi, zi) included in four-dimensional data (xi, yi, zi, vi) of the measurement points Pi (i=1, 2, . . . , n) corresponding to the road surface.

$${e}_{i} = \frac{( {x}_{i} , {y}_{i} , {z}_{i} )}{‖ {x}_{i} , {y}_{i} , {z}_{i} ‖} = ( {x}_{ei} , {y}_{ei} , {z}_{e i} ) \qquad Formula ( i )$$

Next, the estimation unit 112 estimates the moving speed (the absolute moving speed) Vself of the subject vehicle. Specifically, the estimation unit 112 sets a conversion formula for converting the relative moving speed vi of the measurement point Pi corresponding to the road surface into the absolute moving speed, as an objective function L, and solves an optimization problem for optimizing the objective function L to be closer to zero. The measurement point Pi is a measurement point on a road surface, and thus the absolute moving speed of each measurement point must be zero. Therefore, by optimizing the objective function L to be closer to zero, it becomes possible to estimate Vself that is correct. Vself is represented by speed components in XYZ-axis directions as indicated in the following equation (ii). The objective function L is expressed by the following equation (iii). By solving the above optimization problem, Vself that makes the right side of equation (iii) zero is searched for. Note that zero may be set to Vself as an initial value, or Vself that has been estimated in a previous frame may be set.

$${V}_{self} = ( {v}_{x} , {v}_{y} , {v}_{z} ) \qquad Formula ( ii )$$

$$L ( V , f ( A , {V}_{self} ) ) = V + A \cdot {V}_{self}^{T} \qquad Formula ( iii )$$

In the equation (iii), A denotes a matrix of unit vectors ei of n measurement points corresponding to the road surface, and is expressed by a equation (iv). In addition, in the equation (iii), V denotes a matrix of 1×n representing speed components (the relative moving speeds) of n measurement points Pi corresponding to the road surface, and is expressed by a equation (v). The estimation unit 112 acquires Vself obtained by solving the above optimization problem, as an estimated value of the absolute moving speed of the subject vehicle in a current frame.

$$A = {[ {e}_{1} , {e}_{2} , … , {e}_{n} ]}^{T} = [ \begin{matrix}{x}_{e 1} & {y}_{e 1} & {z}_{e 1} \\ {x}_{e 2} & {y}_{e 2} & {z}_{e 2} \\ ⋮ & ⋮ & ⋮ \\ {x}_{e n} & {y}_{en} & {z}_{en}\end{matrix} ] \qquad Formula ( iv )$$

$$V = {[ {v}_{1} , {v}_{2} , … , {v}_{n} ]}^{T} \qquad Formula ( v )$$

The calculation unit 113 calculates the absolute moving speeds of all measurement points, more specifically, all measurement points including the measurement points corresponding to the three-dimensional object, based on the absolute moving speed Vself of the subject vehicle that has been estimated by the estimation unit 112. Here, the absolute moving speed that has been calculated has a negative value when approaching the subject vehicle, and has a positive value when leaving the subject vehicle.

The classification unit 114 classifies the point cloud data that has been acquired by the data acquisition unit 111 into moving point cloud data corresponding to the measurement point at which the absolute value of the absolute moving speed that has been calculated by the calculation unit 113 is equal to or higher than a predetermined speed Th_V and stationary point cloud data corresponding to the measurement point at which the absolute value is lower than the predetermined speed Th_V.

The conversion unit 115 converts the moving point cloud data that has been classified by the classification unit 114 into distance data and absolute speed data (hereinafter, simply referred to as speed data, in some cases) represented in a two-dimensional coordinate system with a horizontal angle θ and a vertical angle q. Hereinafter, the measurement point corresponding to the moving point cloud data will be referred to as a moving point, in some cases.

Specifically, the conversion unit 115 generates distance data, based on position coordinates (xi, yi, zi) of each moving point. The distance data denotes data in which the position coordinates of each moving point represented in the above two-dimensional coordinate system are associated with distance information indicating the distance of each moving point from the subject vehicle (more specifically, the LiDAR 5). Alternatively, the horizontal angle θ and the vertical angle φ, which are setting values at the time of measurement, and the distance data that is a measured value at such a position may be used for association in the above two-dimensional coordinate system.

In addition, the conversion unit 115 generates absolute speed data, based on the position coordinates (xi, yi, zi) of each moving point and the absolute moving speed of each moving point that has been calculated by the calculation unit 113. The absolute speed data denotes data in which the position coordinates of each moving point represented in the above two-dimensional coordinate system are associated with moving speed information indicating an absolute moving speed of each moving point. Alternatively, the horizontal angle θ and the vertical angle φ, which are setting values at the time of measurement, and the absolute speed data that has been converted in the above-described method from relative speed data, which is a measured value at such a position, may be used for association in the above two-dimensional coordinate system.

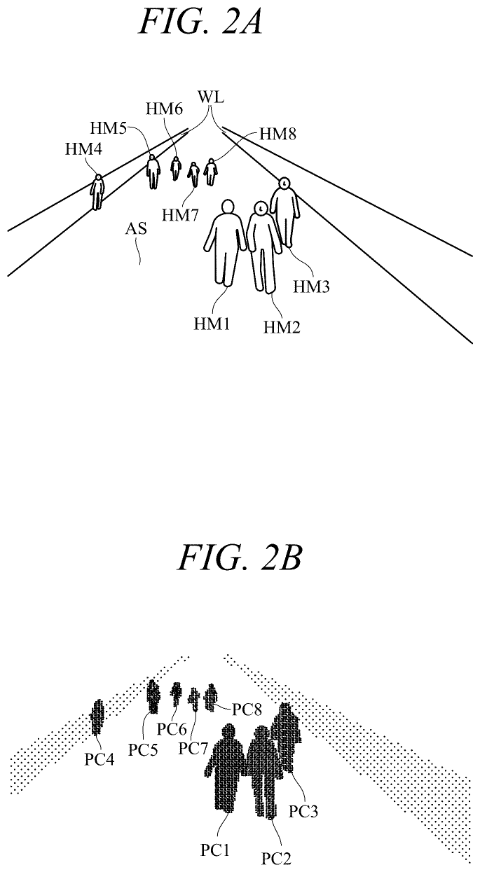

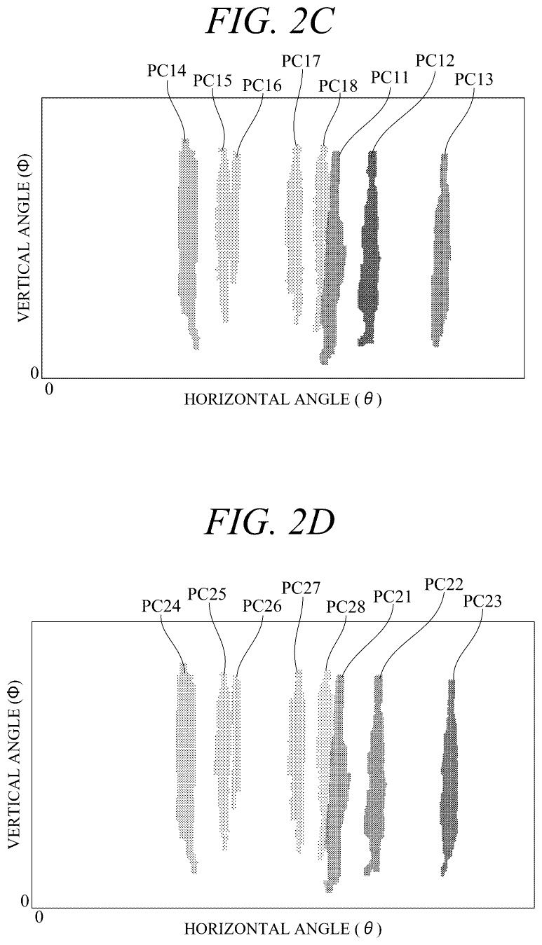

FIGS. 2A to 2D are diagrams for describing data conversion, by the conversion unit 115, from the moving point cloud data to the distance data and the absolute speed data. Here, the data conversion by the conversion unit 115 will be described by using the detection data of the LiDAR installed in a concourse AS in a commercial facility as illustrated in FIG. 2A as an example, instead of using the detection data of the LiDAR mounted on the vehicle. Note that in FIGS. 2A and 2B, a depth direction (an extending direction of the concourse AS) corresponds to X-axis direction, a left-right direction corresponds to Y-axis direction, and a vertical direction corresponds to Z-axis direction.

FIG. 2A illustrates a situation in the concourse AS in the commercial facility, when viewed from the viewpoint of the LiDAR. FIG. 2A is a view illustrating a state in which a plurality of pedestrians HM1 to HM8 come and go in the concourse AS. FIG. 2A illustrates a situation in which the pedestrians HM2 and HM3 are moving (walking) in the same direction (X-axis direction), and the pedestrian HM1 is moving (walking) in the opposite direction. Note that the absolute value of the absolute moving speed of the pedestrians HM1 to HM8 is equal to or higher than a predetermined speed Th_V.

FIG. 2B illustrates an example of detection data (point cloud data) of the LiDAR with regard to the three-dimensional space of FIG. 2A. A lightly shaded region in FIG. 2B represents a measurement point cloud corresponding to a stationary object (a wall WL of the concourse AS in FIG. 2A), that is, stationary point cloud data. A darkly shaded region represents a measurement point cloud corresponding to a moving object (a pedestrian moving in the concourse AS in FIG. 2A), that is, moving point cloud data. Note that measurement point clouds PC1 to PC8 respectively correspond to the pedestrians HM1 to HM8 in FIG. 2A.

FIGS. 2C and 2D illustrate examples of the distance data and the absolute speed data obtained by converting the moving point cloud data of FIG. 2B. The measurement point clouds PC11 to PC18 in FIG. 2C and the measurement point clouds PC21 to PC28 in FIG. 2D respectively represent the measurement point clouds PC1 to PC8 in FIG. 2B in the two-dimensional coordinate system with the vertical angle φ and the horizontal angle θ. Note that in FIGS. 2C and 2D, the vertical axis represents the vertical angle q, and the horizontal axis represents the horizontal angle θ. In addition, in the distance data of FIG. 2C, the moving point that is closer in distance from the LiDAR is indicated in a color of higher density. In the absolute speed data of FIG. 2D, the moving point that is higher in absolute moving speed is indicated in a color of higher density.

When the distance data and the absolute speed data as illustrated in FIGS. 2C and 2D are generated by the conversion unit 115, the filter processing unit 116 applies filter processing on each the distance data and the absolute speed data. More specifically, the filter processing unit 116 performs a kernel operation on the distance data with each moving point as a center position, and calculates a difference in distance data between the respective moving points. In addition, the filter processing unit 116 performs the kernel operation on the absolute speed data with each moving point as a center position, and calculates a difference in absolute speed data between the respective moving points.

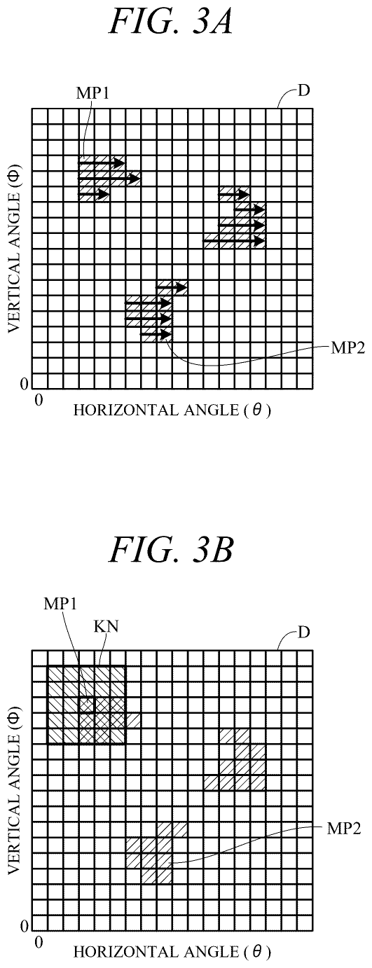

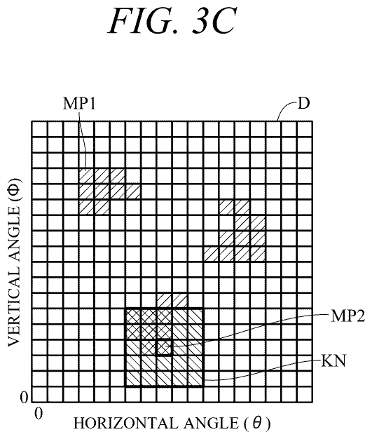

Here, the kernel operation will be described. FIGS. 3A to 3C are diagrams for describing the kernel applied to the distance data. FIG. 3A is a diagram schematically illustrating the distance data. Each grid of distance data D of FIG. 3A corresponds to a position (an irradiation point) irradiated with the irradiation light of the LiDAR 5, and a space in a longitudinal direction and a lateral direction of each grid corresponds to an angular resolution in the longitudinal direction (vertical direction) and the lateral direction (horizontal direction) of the LiDAR. Alternatively, the horizontal angle θ and the vertical angle φ may be calculated from position coordinates of xi, yi, and zi of each point in accordance with a grid range that has been set at a predetermined angular resolution. The shaded grid represents an irradiation point (a measurement point) at which the reflected light from the surface of a moving object is obtained, that is, a moving point.

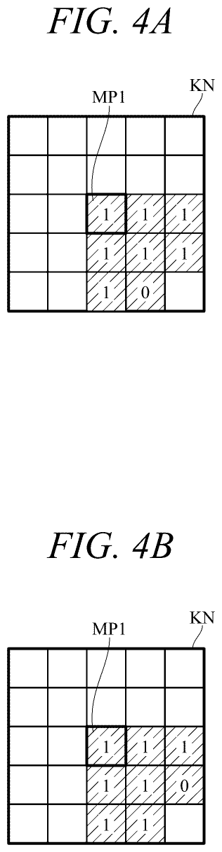

The filter processing unit 116 applies the kernel having each moving point as the center position to each moving point of the distance data D, and repeatedly performs difference calculation processing. The difference calculation processing will be described later with reference to FIGS. 4A to 4C. The filter processing unit 116 performs such a kernel operation from a left upper moving point MP1 to a right lower moving point MP2 in a sequential order indicated by an arrow in FIG. 3A. Therefore, in the kernel operation to be performed first for the distance data D, the kernel is applied to align the center position with the left upper moving point MP1 as illustrated in FIG. 3B. In the processing performed last for the distance data D, as illustrated in FIG. 3C, the kernel is applied to make the center position coincide with the right lower moving point MP2. A region KN in FIGS. 3B and 3C schematically represents the kernel, and a bold line frame in the region KN represents the center position of the kernel.

Note that FIGS. 3B and 3C illustrate the kernel KN having a size of 5×5, but the kernel size may be other than 5×5. Further, the kernel size may be changed in accordance with the distance indicated by the distance information of the moving point (a moving point at the center position of the kernel) to which the kernel is applied.

For example, the filter processing unit 116 may determine the kernel size for every moving point, based on a minimum angular resolution of the LiDAR 5, a minimum size (a minimum size in the horizontal direction and the vertical direction) of the moving object that has been specified beforehand as a detection target, or another optionally specified size (a specified size in the horizontal direction and the vertical direction), and a distance indicated by distance information. In this case, the filter processing unit 116 first calculates a grid width of the kernel KN to be applied to the moving point of a processing target, based on the minimum angular resolution of the LiDAR 5 and the distance indicated by the distance information. For example, in a case where A[rad] denotes the minimum angular resolution and B[m] denotes a distance of the moving point of a processing target from the subject vehicle (the LiDAR 5), the grid width is calculated as A×B. Next, the filter processing unit 116 calculates the number of grids (hereinafter, referred to as a necessary kernel width) such that a distance between both ends (a distance between both ends in the horizontal direction and the vertical direction) of the kernel KN becomes the above minimum size (or the above specified size), based on the grid width that has been calculated and the above minimum size (or the above specified size). More specifically, the number of grids of the kernel KN is calculated so that the distance between both ends of the kernel KN becomes the minimum of values equal to or larger than the above minimum size (or the above specified size). Finally, the filter processing unit 116 determines the kernel size, based on the necessary kernel width that has been calculated. For example, in a case where the necessary kernel width is 9, the kernel size is determined to be 9×9.

Similarly, the filter processing unit 116 applies the kernel using each moving point as the center position to each moving point of the absolute speed data, and repeatedly performs the difference calculation processing.

FIGS. 4A and 4B are diagrams for describing the difference calculation processing in the kernel operation. In the difference calculation processing for the distance data, the distance information of each moving point in the kernel KN is compared with the distance information of the moving point at the center position of the kernel KN, and the absolute value of the difference in value from the moving point at the center position is calculated. Then, an operation result of the moving point having the absolute value equal to or larger than a predetermined threshold Th1 is output as “0”, and an operation result of the moving point having the absolute value smaller than the predetermined threshold Th1 is output as “1”. FIG. 4A illustrates an example of the operation result of the difference calculation processing that has been performed for the kernel KN having the left upper moving point MP1 of the distance data as the center position.

In the difference calculation processing for the absolute speed data, the moving speed information of each moving point in the kernel KN is compared with the moving speed information of the moving point at the center position of the kernel KN, and the absolute value of the difference in value from the moving point at the center position is calculated. Then, an operation result of the moving point having the absolute value equal to or larger than a predetermined threshold Th2 is output as “0”, and an operation result of the moving point having the absolute value smaller than the predetermined threshold Th2 is output as “1”. FIG. 4B illustrates an example of the operation result of the difference calculation processing that has been performed for the kernel KN having the left upper moving point MP1 of the absolute speed data as the center position.

The detection unit 117 detects the position and the size of the moving object in the surroundings of the subject vehicle, based on a result of the kernel operation by the filter processing unit 116, that is, an operation result of the difference calculation processing that has been performed for the distance data and the absolute speed data.

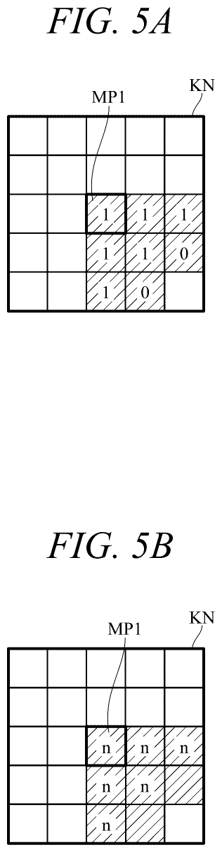

FIGS. 5A and 5B are diagrams for describing detection processing of the moving object by the detection unit 117. The detection unit 117 calculates, for every moving point, a Hadamard product of an operation result of the difference calculation processing that has been obtained from the distance data and an operation result of the difference calculation processing that has been performed on the absolute speed data. FIG. 5A illustrates an operation result of the Hadamard product corresponding to the left upper moving point MP1, that is, an operation result of the Hadamard product between the operation result of FIG. 4A and the operation result of FIG. 4B. As illustrated in FIG. 5A, the detection unit 117 calculates, for every moving point in the kernel KN, a logical product (AND operation) between an operation result of the difference calculation processing that has been obtained from the distance data and an operation result of the difference calculation processing that has been obtained from the absolute speed data.

The detection unit 117 counts the number of moving points each having the operation result of the Hadamard product “1” among the moving points in the kernel. In a case where the counted number is equal to or larger than a predetermined number Th_N, the detection unit 117 determines that the moving point cloud having the operation result of the Hadamard product “1” is a part of the measurement point cloud that has been obtained from the surface of an identical moving object, and assigns an identical identifier (hereinafter, referred to as an identification ID) to the moving point cloud (hereinafter, referred to as an assignment target moving point cloud). FIG. 5B illustrates an example of the identifier that has been assigned, based on the operation result of the Hadamard product in FIG. 5A. In the example illustrated in FIG. 5B, “n (an integer)” is assigned as the identification ID. Note that the predetermined number Th_N may be changed in accordance with the kernel size. For example, as the necessary kernel width is larger, a larger value may be set to the predetermined number Th_N.

The detection unit 117 performs such identifier assignment processing, based on an operation result of the kernel operation (more specifically, an operation result of the Hadamard product), whenever the kernel operation is performed with each moving point as the center position. In such a situation, the detection unit 117 increments the value of the identification ID by 1, whenever the identifier assignment processing is performed. In addition, the detection unit 117 stores a result of the identifier assignment processing in the memory unit 12, whenever the identifier assignment processing is performed. More specifically, the detection unit 117 stores, in the memory unit 12, information (hereinafter, referred to as identifier data) in which position information of the assignment target moving point (position coordinates represented in the two-dimensional coordinate system with the horizontal angle θ and the vertical angle q) is associated with the identification ID. Note that the position information of the moving point in the identifier data may be position coordinates represented in a three-dimensional coordinate system (XYZ coordinate system).

Note that when the identifier assignment processing is repeatedly performed as described above, a moving point to which the identification ID has already been assigned in the identifier assignment processing that has been performed before (hereinafter, referred to as an already assigned moving point) is included in some cases in the assignment target moving point cloud that has been selected from the kernel. In such cases, the detection unit 117 assigns the identification ID having an identical value to the identification ID of the already assigned moving point to a moving point to which the identification ID is not assigned (hereinafter, referred to as an unassigned moving point) in the assignment target moving point cloud. For example, in a case where there is an already assigned moving point to which an identification ID “4” has been assigned in the assignment target moving point cloud, the detection unit 117 assigns the identification ID “4” to an unassigned moving point.

In addition, in a case where there is a plurality of already assigned moving points to which different identification IDs have been assigned in the assignment target moving point cloud, the detection unit 117 assigns an identification ID having the smallest value (hereinafter, referred to as “Min”) among the identification IDs of the already assigned moving points to the unassigned moving point. Furthermore, the detection unit 117 reassigns “Min” to the identification ID of the already assigned moving point to which the identification ID other than “Min” has been assigned. For example, in a case where the already assigned moving point to which the identification ID “3” has been assigned and the already assigned moving point to which the identification ID “4” has been assigned are present in the assignment target moving point cloud that has been selected from the kernel, the detection unit 117 assigns the identification ID “3” to the unassigned moving point. In addition, the detection unit 117 reassigns “3” to the identification ID of the already assigned moving point to which the identification ID “4” has been assigned. Note that in a case where one or a plurality of already assigned moving points to which the identification ID “4” has been assigned is/are present outside the kernel of a processing target, the already assigned moving point(s) is (are) also part(s) of the measurement point cloud that has been obtained from the surface of an identical moving object. Therefore, the detection unit 117 may also reassign “3” to the identification IDs of the already assigned moving points.

The detection unit 117 classifies the moving point cloud data in FIG. 2B for every moving point cloud (cluster) to which the identical identification ID has been assigned, based on the identifier data. Furthermore, the detection unit 117 detects a circumscribed region (a bounding box) of each cluster in the moving point cloud data, and detects the position and the size of each moving object in the three-dimensional space (XYZ space) in the surroundings of the subject vehicle, based on the position and the size on the moving point cloud data in each circumscribed region that has been detected. The detection unit 117 outputs information indicating a detection result of the moving object to the memory unit 12, a display device, not illustrated, or the like.

Depending on the type of the moving object, by the way, the absolute moving speed of a main body of the moving object may be different from the absolute moving speed of a part attached to such a main body. For example, pedestrians move while moving four limbs. Thus, the absolute moving speeds of the torso and the four limbs of a moving pedestrian to be calculated by the calculation unit 113 are different from each other in some cases. In such cases, when an object is detected in consideration of the absolute moving speed of each moving point as described above, there is a possibility that the torso and the four limbs of the pedestrian might be detected as separate moving objects. Hence, in order to address such a problem, the detection unit 117 performs connection processing of a moving object, as will be described below.

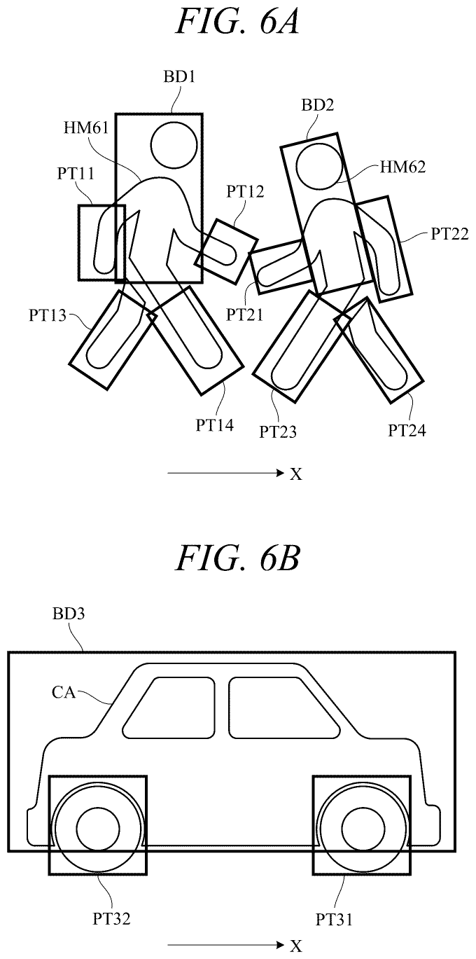

FIGS. 6A and 6B are diagrams for describing the connection processing of a moving object. FIG. 6A is a schematic diagram of a pedestrian HM61 moving in X direction and a pedestrian HM61 moving to face the pedestrian HM62, when viewed from Y direction. In FIG. 6A, bounding boxes that have been detected by the detection unit 117 are schematically illustrated respectively as square frames BD1, BD2, PT11 to PT14, and PT21 to PT24. The bounding boxes BD1 and BD2 respectively correspond to the torsos of the pedestrians HM61 and HM62. The bounding boxes PT11, PT12, PT21, and PT22 respectively correspond to arms of the pedestrians HM61 and HM62. The bounding boxes PT13, PT14, PT23, and PT24 respectively correspond to legs of the pedestrians HM61 and HM62.

The detection unit 117 determines whether a bounding box, the distance from which to another bounding box having a size equal to or larger than a predetermined size is shorter than a predetermined length, and which has its own size smaller than a predetermined length (hereinafter, referred to as a connecting target bounding box or simply as a connecting target box) is present in the bounding boxes that have been detected from the moving point cloud. Upon determination that a connecting target box is present, the detection unit 117 connects the connecting target box to the above another bounding box (hereinafter, referred to as a connected target bounding box or simply a connected target box). In the example of FIG. 6A, the bounding boxes PT11 to PT14 are selected as the connecting target boxes, and the bounding box BD1 is selected as the connected target box corresponding to the connecting target boxes PT11 to PT14. As a result, the bounding boxes PT11 to PT14 are connected to the bounding box BD1. Similarly, the bounding boxes PT21 to PT24 are connected to the bounding box BD2. This suppresses the detection of each of the torsos and the four limbs of the pedestrians HM61 and HM62 as separate moving objects. Note that the bounding boxes BD1 and BD2, each of which has a size equal to or larger than a predetermined size, are the connected target boxes. Therefore, they are not connected to each other, even though the distance between them is shorter than the predetermined length. In addition, PT11 to PT14 and PT21 to PT24, each of which has a size smaller than the predetermined size, are the connecting boxes. Therefore, they are not connected to each other, even though the distance between them is shorter than the predetermined length.

Note that in FIG. 6A, the torso and the four limbs of the pedestrian have been described as an example. However, also with regard to a vehicle traveling in the surroundings of the subject vehicle, the absolute moving speeds to be calculated by the calculation unit 113 are different between the main body of the vehicle and parts such as wheels attached to the main body, in some cases. FIG. 6B is a schematic diagram, when a vehicle CA moving in X direction is viewed from Y direction. In FIG. 6B, square frames BD3, PT31, and PT32 in FIG. 6B schematically illustrate the bounding boxes that have been detected from the moving point cloud data. The bounding box BD3 corresponds to the main body of the vehicle CA. The bounding boxes PT31 and PT32 respectively correspond to the front wheel and the rear wheel of the vehicle CA. The main body of the vehicle CA and the parts such as wheels attached to the main body have the same moving speed in the advancing direction of the vehicle. However, the relative positions with respect to the LiDAR 5 are different from one another, and thus the calculation unit 113 calculates different relative moving speeds, in some cases. Also in such cases, by performing the above connection processing, it becomes possible to connect the bounding boxes PT31 and PT32 to the bounding box BD3. As a result, it becomes possible to suppress the detection of the main body and the parts of the vehicle CA as separate moving objects.

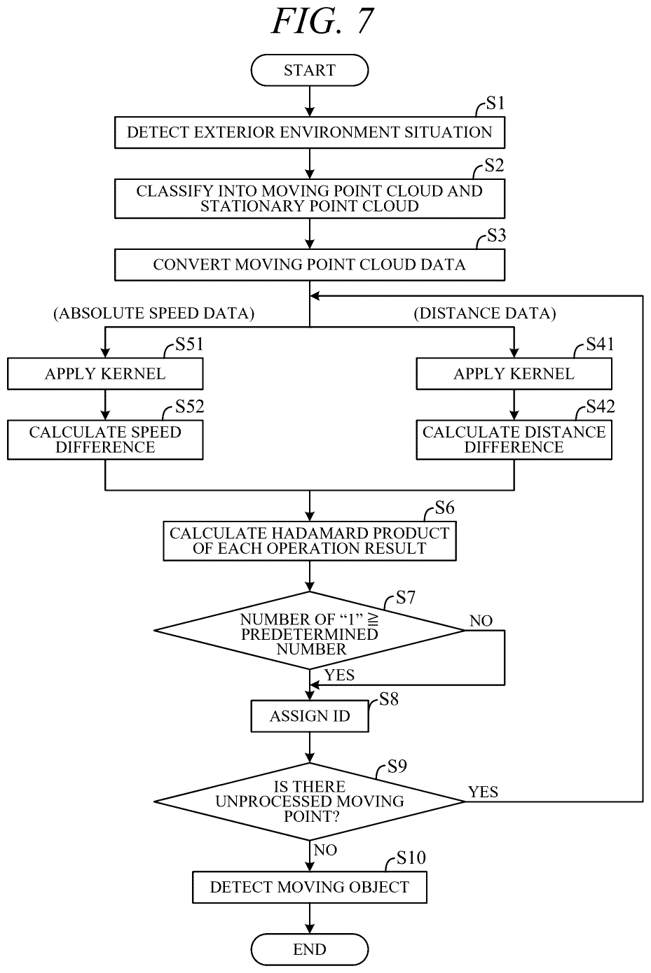

FIG. 7 is a flowchart illustrating an example of processing performed by the processing unit 11 of the controller 10 in FIG. 1 in accordance with a predetermined program. The processing illustrated in this flowchart is repeated at a predetermined cycle, while the object detection apparatus 50 is running. More specifically, the processing is repeated every cycle in accordance with the frame rate of the LiDAR 5.

First, in step S1, an exterior environment situation in the surroundings of the subject vehicle is detected. Specifically, an irradiation command is transmitted to the LiDAR 5, and point cloud data (detection data) is acquired including position information and speed information of a measurement point at which the reflected wave of the electromagnetic wave that has been irradiated from the LiDAR 5 in accordance with the irradiation command is obtained. In step S2, the point cloud data acquired in step S1 is classified into moving point cloud data and stationary point cloud data. More specifically, the point cloud data is classified into the moving point cloud data corresponding to the measurement point at which the absolute value of the absolute moving speed is equal to or higher than the predetermined speed Th_V and the stationary point cloud data corresponding to any other measurement point.

Next, the processing of steps S3 to S9 is performed on the moving point cloud data that has been classified from the point cloud data. Note that predetermined processing is also performed on the stationary point cloud data by the controller 10, but its description will be omitted.

In step S3, the moving point cloud data is converted into the distance data and the absolute speed data represented in the two-dimensional coordinate system with the horizontal angle θ and the vertical angle φ. Next, the processing in steps S41 to S42 is performed on the distance data, and in parallel, the processing in steps S51 to S52 is performed on the absolute speed data. Note that the processing of steps S41 to S42 and the processing of steps S51 to S52 may be performed sequentially.

In step S41, the kernel having the moving point as the center position is applied to a single moving point included in the distance data. In step S42, difference calculation processing is performed on the kernel applied in step S41. Specifically, the distance information of each moving point in the kernel is compared with the distance information of the moving point at the center position of the kernel, and the absolute value of the difference in value from the moving point at the center position is calculated. Then, an operation result of the moving point having the absolute value equal to or larger than a predetermined threshold Th1 is output as “0”, and an operation result of the moving point having the absolute value smaller than the predetermined threshold Th1 is output as “1”.

In step S51, the kernel having the moving point as the center position is applied to a single moving point included in the absolute speed data. In step S52, the difference calculation processing is performed on the kernel applied in step S51. Specifically, the moving speed information of each moving point in the kernel is compared with the moving speed information of the moving point at the center position of the kernel, and the absolute value of the difference in value from the moving point at the center position is calculated. Then, an operation result of the moving point having the absolute value equal to or larger than a predetermined threshold Th2 is output as “0”, and an operation result of the moving point having the absolute value smaller than the predetermined threshold Th2 is output as “1”.

In step S6, a Hadamard product of an operation result of the difference calculation processing in step S42 (FIG. 4A) and an operation result of the difference calculation processing in step S52 (FIG. 4B) is calculated. In step S7, the number of moving points having an operation result “1” is counted with reference to the operation result of the Hadamard product in step S6 (FIG. 5A), and it is determined whether the number is equal to or larger than the predetermined number Th_N. In a case where a negative determination is made in step S7, the processing proceeds to step S9. In a case where an affirmative determination is made in step S7, an identification ID is assigned to the moving point having an operation result of the Hadamard product “1” in step S8. Specifically, information in which the position information of the moving point having the operation result of the Hadamard product “1” is associated with the identification ID, that is, the identifier data is stored in the memory unit 12.

In step S9, it is determined whether an unprocessed moving point on which the processing in steps S41 to S42 and S51 to S52 is not performed is included in the distance data and the absolute speed data. In a case where an affirmative determination is made in step S9, the moving point to be a processing target next is selected in accordance with the order indicated by the arrow in FIG. 3A, the kernel is applied to the selected moving point, and the processing of steps S41 to S42, S51 to S52, and S6 to S8 is performed.

In a case where a negative determination is made in step S9, in step S10, the moving object is detected, based on the identifier data stored in the memory unit 12. Specifically, the moving point cloud data is classified for every moving point cloud (cluster) to which the identical identification ID has been assigned, based on the identifier data. Then, the bounding box of each cluster on the moving point cloud data is detected, and the position and the size in the three-dimensional space of each moving object in the surroundings of the subject vehicle are detected, based on the position and the size of each bounding box on the moving point cloud data. Note that in a case where the bounding box is connected in the above connection processing, the position and the size of the moving object in the surroundings of the subject vehicle in the three-dimensional space are detected, based on the position and the size of the bounding box that has been connected on the moving point cloud data.

According to the above-described embodiments heretofore, the following operation and effects are obtained.

(1) The object detection apparatus 50 includes: the LiDAR 5, which is mounted on a subject vehicle, and which irradiates a three-dimensional space in the surroundings of the subject vehicle with an electromagnetic wave to detect an exterior environment situation of the subject vehicle, based on a reflected wave; the data acquisition unit 111, which acquires point cloud data from a detection unit, the point cloud data including three-dimensional position information of a plurality of measurement points on a surface of an object from which the reflected wave is obtained, and first speed information indicating relative moving speeds of the plurality of measurement points; the estimation unit 112, as a speed acquisition unit, which acquires second speed information indicating an absolute moving speed of the subject vehicle; the calculation unit 113, which respectively calculates absolute moving speeds of the plurality of measurement points, based on the first speed information and the second speed information; the classification unit 114, which classifies the plurality of measurement points into a plurality of moving points and a plurality of stationary points, the plurality of moving points having absolute values of the absolute moving speeds that have been calculated by the calculation unit 113 equal to or higher than a predetermined speed, the plurality of stationary points having the absolute values lower than the predetermined speed; the conversion unit 115, as a generation unit, which generates distance data (FIG. 2C) indicating distances to the plurality of moving points from the subject vehicle and speed data (FIG. 2D) indicating the absolute moving speeds of the plurality of moving points that have been calculated by the calculation unit 113; the filter processing unit 116, which performs a kernel operation on each the distance data and the speed data that have been generated by the conversion unit 115 with each of the plurality of moving points as a center position, and which calculates differences between the distance data and the speed data between the plurality of moving points; and the detection unit 117, which detects a position and a size of each of a plurality of moving objects in the surroundings of the subject vehicle, based on a result of the kernel operation. In the kernel operation, the filter processing unit 116 calculates the number of second moving points in the kernel in which the difference of the distance data from the first moving point set as the center position is smaller than the predetermined threshold Th1 and the difference of the speed data from the first moving point is smaller than the predetermined threshold Th2. In a case where the number of second moving points in the kernel is equal to or larger than a predetermined number (Th_N−1), the detection unit 117 assigns identification IDs of different values for every kernel operation to the first moving point and the second moving point in the kernel. Note that the detection unit 117 further detects the position and the size of a single moving object, based on the position and the size of the moving point cloud to which the identification ID of an identical value has been assigned, in the plurality of moving points.

In this manner, by detecting the moving object in a parallel calculation method of the kernel for use in image processing or the like, it becomes possible to detect the moving object without using a clustering method with a large calculation load such as Density-based spatial clustering of applications with noise (DBSCAN). As a result, the processing load of the device can be reduced. In addition, by detecting the moving object using a result of the kernel operation that has been performed for each the distance data and the absolute speed data, it becomes possible to detect the moving objects approaching each other, such as pedestrians passing each other, as different moving objects. As a result, the detection accuracy of the moving object can be improved.

(2) When assigning an identification ID to a first moving point and a second moving point in kernel, in a case where an already assigned moving point to which the identification ID has already been assigned is included in the first moving point and the second moving point, the detection unit 117 assigns an identification ID having an identical value to the identification ID that has been assigned to the already assigned moving point. Furthermore, when assigning the identification ID to the first moving point and the second moving point in the kernel, in a case where a plurality of already assigned moving points to which different identification IDs have been assigned are included in the first moving point and the second moving point, the detection unit 117 assigns an identification ID having the smallest value among the identification IDs that have been assigned to the plurality of already assigned moving points. This further enables improvement in the detection accuracy of the moving object in the parallel calculation method of the kernel.

(3) For every kernel operation, the filter processing unit 116 determines the size of the kernel, based on the distance from the subject vehicle (the LiDAR 5) at the moving point that is indicated by the distance data and that has been set as the center position. Specifically, for every kernel operation, the filter processing unit 116 determines the size of the kernel, based on the distance from the subject vehicle at the moving point that is indicated by the distance data and that has been set as the center position, and the sizes in the horizontal direction and the vertical direction that have been specified beforehand (the above minimum size or the above specified size). More specifically, for every kernel operation, the filter processing unit 116 calculates the number of grids of the kernel, based on a grid width determined (calculated) by the distance from the subject vehicle and the minimum resolution of the LiDAR 5 so that the distance between both ends of the kernel becomes the minimum among values equal to or larger than the size in the horizontal direction and the vertical direction that have been specified beforehand. This enables detection of the moving object with accuracy, regardless of the distance from the subject vehicle to the moving object.

(4) The detection unit 117 classifies the plurality of moving points for every moving point cloud to which the identical identification ID has been assigned, also detects a circumscribed region of each moving point cloud, and detects the position and the size of the moving object corresponding to each moving point cloud, based on the position and the size of the circumscribed region of each moving point cloud. In this situation, in a case where the circumscribed region of each moving point cloud includes a first circumscribed region having a size smaller than a predetermined size and a second circumscribed region having a size equal to or larger than the predetermined size and a distance from the first circumscribed region smaller than a predetermined length, the detection unit 117 connects the first circumscribed region to the second circumscribed region. This enables appropriate detection of a moving object including a main body and parts such as the torso and four limbs of a person or a main body and wheels of a vehicle, as one moving object.

The above embodiments may be modified into various modes. Hereinafter, modifications will be described. In the above embodiment, the LiDAR 5 as a detection unit is mounted on the vehicle, irradiates the three-dimensional space in the surroundings of the vehicle with the electromagnetic wave, and detects the exterior environment situation in the surroundings of the vehicle, based on the reflected wave. However, the detection unit may be any detection unit capable of obtaining a distance and a speed. For example, it may be a radar or the like other than the LiDAR. In addition, a moving body in which the detection unit is mounted may be a self-propelled robot, instead of the vehicle.

Further, in the above embodiment, the estimation unit 112, which serves as the speed acquisition unit, selects the measurement point Pi as the representative measurement point from among the remaining measurement points excluding the measurement point corresponding to the three-dimensional object from the plurality of measurement points, also estimates the absolute moving speed of the subject vehicle, based on the position information and the speed information of the representative measurement point that has been extracted from the point cloud data acquired by the data acquisition unit 111, and acquires an estimation result as the second speed information. However, the speed acquisition unit may acquire, as the second speed information, the measurement result of the absolute moving speed of the subject vehicle that has been acquired by a measuring instrument included in an internal sensor group 3. In this case, the object detection apparatus 50 includes at least a vehicle speed sensor of the internal sensor group 3, as the measuring instrument. In addition, the speed acquisition unit may calculate and acquire the absolute moving speed of the subject vehicle, based on the current position of the subject vehicle that has been measured by a position measurement unit 2. In this case, the object detection apparatus 50 includes the position measurement unit 2.

In addition, in the above embodiment, the filter processing unit 116 performs the kernel operation on the distance data represented in the two-dimensional coordinate system with the horizontal angle θ and the vertical angle q, and calculates the difference of the distance data between the respective moving points. However, the filter processing unit may perform the kernel operation on the position coordinates (position coordinates represented in the three-dimensional coordinate system (XYZ coordinate system)) of each moving point of the moving point cloud data. Then, the difference between X coordinate, Y coordinate, and Z coordinate between the respective moving points may be calculated. In this case, in the difference calculation processing with respect to X coordinate, the filter processing unit 116 compares X coordinate of each moving point in the kernel with X coordinate of the moving point at the center position of the kernel, and calculates the absolute value of the difference in value from the moving point at the center position. The filter processing unit 116 also performs similar difference calculation processing on Y coordinate and Z coordinate. The detection unit 117 calculates, for every moving point, a Hadamard product of operation results of the difference calculation processing for each X coordinate, Y coordinate, Z coordinate, and the absolute speed data. Note that instead of performing the difference calculation processing on all of X coordinate, Y coordinate, and Z coordinate, the difference calculation processing may be performed on any of X coordinate, Y coordinate, and Z coordinate, and the Hadamard product of its operation result and an operation result of the difference calculation processing on the absolute speed data may be calculated for every moving point.

Further, in the above embodiment, a driving control unit 118 conducts the travel control of the subject vehicle to avoid a collision or contact with the object that has been detected by the detection unit 117. However, the driving control unit 118, which serves as a notification unit, may predict a possibility of collision or contact with the moving object, based on the size, the position, and the moving speed of the moving object that has been detected by the detection unit 117. Then, in a case where the possibility of collision or contact with the moving object is equal to or higher than a predetermined degree, an occupant of the subject vehicle may be notified of information (video information or audio information) for calling for attention about collision or contact with the moving object that has been detected by the detection unit 117 via a display or a speaker, not illustrated, included in a vehicle control apparatus 100.

Furthermore, in the above embodiment, the object detection apparatus 50 is applied to a self-driving vehicle, but the object detection apparatus 50 is also applicable to any vehicle other than self-driving vehicle. For example, the object detection apparatus 50 is also applicable to a manual driving vehicle including advanced driver-assistance systems (ADAS).

The above embodiment can be combined as desired with one or more of the above modifications. The modifications can also be combined with one another.

According to the present invention, it becomes possible to accurately detect a moving object while reducing the processing load of the device.

Above, while the present invention has been described with reference to the preferred embodiments thereof, it will be understood, by those skilled in the art, that various changes and modifications may be made thereto without departing from the scope of the appended claims.

What is claimed is:

1. A object detection apparatus comprising:
a detector mounted on a mobile body and configured to irradiate a surrounding of the mobile body with an electromagnetic wave to detect an exterior environment situation in the surrounding of the mobile body based on a reflected wave; and
a microprocessor, wherein
the microprocessor is configured to perform:
acquiring point cloud data for every predetermined period of time, the point cloud data including three-dimensional position information of a plurality of measurement points on a surface of an object from which the reflected wave is obtained and first speed information indicating a relative moving speed of the plurality of measurement points;
acquiring second speed information indicating an absolute moving speed of the mobile body;
calculating absolute moving speeds of each of the plurality of measurement points, based on the first speed information and the second speed information;
classifying the plurality of measurement points into a plurality of moving points and a plurality of stationary points, the plurality of moving points having absolute values of the absolute moving speeds equal to or higher than a predetermined speed, the plurality of stationary points having the absolute values lower than the predetermined speed;
generating distance data indicating distances to the plurality of moving points from a subject vehicle and speed data indicating the absolute moving speeds of the plurality of moving points;
performing a kernel operation on each of the distance data and the speed data with each of the plurality of moving points as a center position, and calculating differences between the distance data and the speed data between the plurality of moving points; and
detecting a position and a size of each of a plurality of moving objects in the surroundings of the mobile body, based on a result of the kernel operation.

2. The object detection apparatus according to claim 1, wherein
the microprocessor is configured to perform
in the kernel operation, calculating a number of second moving points in the kernel in which a difference of the distance data from the first moving point set as the center position is smaller than a first predetermined threshold and a difference of the speed data from the first moving point is smaller than a second predetermined threshold,
in a case where the number of second moving points in the kernel is equal to or larger than a predetermined number, assigning identifications of different values for every kernel operation to the first moving point and the second moving point in the kernel, and detecting a position and a size of a single moving object, based on a position and a size of the moving point cloud to which the identification of an identical value has been assigned, in the plurality of moving points.

3. The object detection apparatus according to claim 2, wherein
the microprocessor is configured to perform
when assigning an identification to a first moving point and a second moving point in kernel, in a case where an already assigned moving point to which the identification has already been assigned is included in the first moving point and the second moving point, assigning an identification having an identical value to the identification assigned to the already assigned moving point.

4. The object detection apparatus according to claim 3, wherein
the microprocessor is configured to perform
when assigning the identification to the first moving point and the second moving point in the kernel, in a case where a plurality of already assigned moving points to which different identifications have been assigned are included in the first moving point and the second moving point, assigning an identification having the smallest value among the identifications assigned to the plurality of already assigned moving points.

5. The object detection apparatus according to claim 1, wherein
the microprocessor is configured to perform
for every kernel operation, determining a size of the kernel, based on the distance from the moving body at the moving point set as the center position, indicated by the distance data.

6. The object detection apparatus according to claim 5, wherein
the microprocessor is configured to perform
for every kernel operation, determining a size of the kernel, based on the distance from the moving body at the moving point set as the center position, indicated by the distance data, and sizes in a horizontal direction and a vertical direction specified beforehand of the moving object.

7. The object detection apparatus according to claim 6, wherein
the microprocessor is configured to perform
calculating a number of the kernel such that a distance between both ends of the kernel becomes a minimum size of values equal to or larger than sizes in the horizontal direction and the vertical direction specified beforehand, based on a grid width of the kernel calculated based on a minimum angular resolution of the detection unit and the distance from the moving body.

8. The object detection apparatus according to claim 6, wherein
the sizes in the horizontal direction and the vertical direction specified beforehand are minimum sizes of the moving object specified beforehand as a detection target.

9. The object detection apparatus according to claim 2, wherein
the microprocessor is configured to perform
classifying the plurality of moving points for every moving point cloud to which the identical identification has been assigned, also detecting a circumscribed region of each moving point cloud, and detecting a position and a size of the moving object corresponding to each moving point cloud, based on a position and a size of the circumscribed region of each moving point cloud.

10. The object detection apparatus according to claim 9, wherein
the microprocessor is configured to perform
in a case where the circumscribed region of each moving point cloud includes a first circumscribed region having a size smaller than a predetermined size and a second circumscribed region having a size equal to or larger than the predetermined size and a distance from the first circumscribed region smaller than a predetermined length, connecting the first circumscribed region to the second circumscribed region.

11. The object detection apparatus according to claim 1, wherein
the detection unit is a Lidar.
